(19) United States
(12) Patent Application Publication
(10) Pub. No.: US 2017/0360000 A1
(43) Pub. Date: Dec. 21, 2017

(54) SQUEEZE CHUTE WITH LIVESTOCK RESTRAINTS

(71) Applicant: Tommie C. Gipson, Eaton, CO (US)

(72) Inventor: Tommie C. Gipson, Eaton, CO (US)

(21) Appl. No.: 15/273,501

(22) Filed: Sep. 22, 2016

Related U.S. Application Data
(60) Provisional application No. 62/375,070, filed on Aug. 15, 2016.
(60) Provisional application No. 62/352,042, filed on Jun. 20, 2016.

(51) Int. Cl. A01K 1/06

(52) U.S. Cl. CPC A01K 1/0613

(57) ABSTRACT

Embodiments of the invention include a squeeze chute for temporarily confining an animal while it is being inspected or treated, wherein the squeeze chute has a pair of side grippers and a rear pusher that cooperate to restrain the movement of the animal within the squeeze chute. Certain embodiments of both the side grippers and the pusher are rotatable about the top rails of the chute as well as vertically extensible and retractable from the top rails on which they are mounted.

### CROSS-REFERENCE TO RELATED APPLICATION

The present application, pursuant to 35 U.S.C. 111(b), claims the benefit of the earlier filing date of provisional application Ser. No. 62/352,042 filed Jun. 20, 2016 and entitled “Pneumatic Squeeze Chute” and provisional application Ser. No. 62/375,070 filed Aug. 15, 2016 and entitled “Squeeze Chute with Livestock Restraints.”

### BACKGROUND OF THE INVENTION

### Field of the Invention

This invention is related to a squeeze chute having at least one restraint mechanism for temporarily confining an animal while it is being inspected or treated. More particularly, the present invention is related to a squeeze chute having a pair of side grippers and a rear pusher, wherein both the side grippers and the pusher are horizontally and vertically extensible and retractable from the top rail on which they are mounted.

### Description of the Related Art

Ranchers and livestock producers must manage their herds in a manner that is safe for the livestock manager, the livestock, and the veterinarian. Restraining mechanisms such as a squeeze chute facilitate the handling of livestock, especially during veterinary operations such as pregnancy examinations, tagging, inoculations and the like.

The safe and effective restraining of an animal during veterinary operations has always been a problem for the animal, rancher and/or veterinarian. currently available squeeze chutes have either a manual or hydraulic mechanism to squeeze or constrict the animal from the lower side panels. In order to effectively restrain the animal for invasive procedures, the lower panels can exert enough pressure on the thoracic cavity of the animal to cause internal injury to the animal being constrained. Furthermore, none of the available squeeze chutes have a rear pusher that can effectively prevent the animal being constrained from backing up.

A need exists for a squeeze chute that is safer for the animal, rancher and/or veterinarian while the animal is undergoing inspection or treatment.

### SUMMARY OF THE INVENTION

Embodiments of the invention include a squeeze chute for temporarily confining an animal while it is being inspected or treated, wherein the squeeze chute has a pair of side grippers and a rear pusher that cooperate to restrain the movement of the animal within the squeeze chute. Certain embodiment of both the side grippers and the pusher are horizontally and vertically extensible and retractable from the top rails on which they are mounted.

Embodiments of the present invention provide an animal restraining chute having: a) a rectangular chute having an entrance, an exit, an interior, a top, a first side and a second opposed side, wherein the first and second sides include a tubular top rail; b) a first side restraint mechanism mounted on the top rail of the first side and a second side restraint mechanism mounted on the top rail of the second side, wherein each restraint mechanism is rotatable about the top rail that it is mounted on, the side restraint rotatable between a substantially horizontal position away from the interior of the chute to a substantially vertical position closer to the interior of the chute and wherein each side restraint has a gripper that is vertically extendable or retractable for adjusting a distance between a distal end of the gripper to the top rail on which the restraint mechanism is mounted; and c) a pusher mounted on a horizontal cross-rail that is transverse to the top rails of the first and second sides, wherein the pusher is rotatable about the horizontal cross-rail that it is mounted on, the pusher is rotatable between a substantially horizontal position away from the interior of the chute to a more vertical position closer to the interior of the chute and wherein the pusher is movable toward and away from the interior of the chute along a longitudinal axis of the chute.

One embodiment of the present invention is an animal holding chute including: a) a rectangular chute having an entrance gate, an exit gate, an interior, a top, a first side and a second opposed side, wherein the first and second sides include a tubular first and second top side rail; and b) a first restraint mechanism mounted on the first top side rail and a second restraint mechanism mounted on the second top side rail opposite the first restraint mechanism, wherein each restraint mechanism having a tubular gripper support encircling a segment of the top side rail on which the restraint mechanism is mounted on, a gripper, a gripper extender having a first end attached to the gripper support and a second end attached to the gripper, wherein the extension or retraction of the gripper extender adjusts the distance between the gripper support and the gripper, and a gripper rotator having a hydraulic cylinder mounted on the top of the chute and a cylinder rod attached to the gripper support, wherein the extension or retraction of the cylinder rod rotates the restraint mechanism about the top rail on which it is mounted between a substantially horizontal position away from the interior of the chute to a substantially vertical position closer to the interior of the chute.

Another embodiment of the present invention is an animal holding chute including: a) a rectangular chute having an entrance gate, an exit gate, an interior, a top, a first side and a second opposed side, wherein the first and second sides include a tubular first and second top side rail; and b) a pusher rotatably mounted on a horizontal cross-rail that is transverse to the first and second top side rails, the pusher having a tubular pusher support encircling a segment of the cross-rail; a pusher body having a proximal end mounted on the pusher support and an opposed distal end; a pusher rotator having a hydraulic rotator cylinder mounted on a first end to the pusher support and a second end mounted to the cross-rail, wherein the extension or retraction of a rotator cylinder rod rotates the restraint mechanism about the cross-rail between a substantially horizontal position away from the interior of the chute to a substantially vertical position closer to the interior of the chute; and a pusher placement mechanism having a hydraulic placement cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles wherein the extension or retraction of the rod end of the placement cylinder moves the pusher toward and away from the interior of the chute along a longitudinal axis of the chute.

Yet another embodiment of the present invention is an animal holding chute including: a) a rectangular chute having an entrance gate, an exit gate, an interior, a top, a first side and a second opposed side, wherein the first and second sides include a tubular first and second top side rail; b) a first restraint mechanism mounted on the first top side rail and a second restraint mechanism mounted on the second top side rail opposite the first restraint mechanism, wherein each restraint mechanism has a tubular gripper support encircling a segment of the top side rail on which the restraint mechanism is mounted on, a gripper, a gripper extender having a first end attached to the gripper support and a second end attached to the gripper, wherein the extension or retraction of the gripper extender adjusts the distance between the gripper support and the gripper, and a gripper rotator having a hydraulic cylinder mounted on the top of the chute and a cylinder rod attached to the gripper support, wherein the extension or retraction of the cylinder rod rotates the restraint mechanism about the top rail on which it is mounted between a substantially horizontal position away from the interior of the chute to a substantially vertical position closer to the interior of the chute; and c) a pusher rotatably mounted on a horizontal cross-rail that is transverse to the first and second top side rails, the pusher having a tubular pusher support encircling a segment of the cross-rail; a pusher body having a proximal end mounted on the pusher support and an opposed distal end; a pusher rotator having a hydraulic rotator cylinder mounted on a first end to the pusher support and a second end mounted to the cross-rail, wherein the extension or retraction of a rotator cylinder rod rotates the restraint mechanism about the cross-rail between a substantially horizontal position away from the interior of the chute to a substantially vertical position closer to the interior of the chute; and a pusher placement mechanism having a hydraulic placement cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles wherein the extension or retraction of the rod end of the placement cylinder moves the pusher toward and away from the interior of the chute along a longitudinal axis of the chute.

Another embodiment of the present invention is a livestock holding chute comprising: a rectangular chute having an entrance, an exit, a first side and a second opposed side, wherein the first and second sides include a tubular top rail having a top rail outer diameter; a restraint mechanism mounted on the top rail of the first and second sides, wherein the restraint mechanism includes a tubular restraint support having a bore with an inner diameter larger than the rail outer diameter, wherein the inner diameter of the bore of the restraint support encircles a portion of the length of the top rail of the first and second sides; an arcuate gripper; a gripper extender having a first end attached to the restraint support and a second end attached to the gripper, wherein the extension or retraction of the gripper extender adjusts a distance between the top rail and the gripper; a gripper swivel that attaches the gripper to the gripper extender, wherein the gripper swivel allows the gripper to vertically rotate about the second end of the gripper extender; and a gripper rotator having a hydraulic cylinder mounted on a first end to the tubular support and a second end mounted to the top rail encircled by the tubular support; and a pusher assembly mounted on a horizontal cross-rail that is a transverse to the top rails of the first and second sides, wherein the pusher assembly includes a tubular pusher support having a bore with an inner diameter larger than the cross-rail outer diameter, wherein the inner diameter of the bore of the tubular support encircles a portion of the length of the top rail of the first and second side; a pusher body; a pusher extender having a first end attached to the pusher support and a second end attached to the pusher body, and a pusher rotator having a hydraulic cylinder mounted on a first end to the pusher support and a second end mounted to the cross-rail encircled by the pusher support.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A, 1B and 1C are plan views of embodiments of a holding chute framework.

FIG. 2A is an oblique view of the inwardly facing side of one embodiment of the restraint mechanism.

FIG. 2B is an oblique view of the outwardly facing side of the embodiment of the restraint mechanism shown in FIG. 2A.

FIGS. 2C and 2D are oblique views of the outwardly facing side of the embodiment of the restraint mechanism shown in FIG. 2B where the gripper is extended in a downward direction.

FIG. 3A is a side sectional view of one embodiment of the gripper extender.

FIG. 3B is a side view of one embodiment of the restraint mechanism.

FIG. 4 illustrates a side view of a restraint mechanism mounted on a top side rail of the holding chute.

FIG. 5 is a schematic cross sectional view of the opposed grippers abutting the sides of an animal being restrained in the holding chute.

FIG. 6A is a plan view of one embodiment of a pusher assembly mounted on a transverse top rail of the holding chute.

FIG. 6B is a side view of one embodiment of a pusher assembly mounted on a transverse top rail of the holding chute having an open entrance gate.

FIGS. 7A and 7B illustrate a couple of embodiments of a pusher assembly.

FIGS. 7C and 7D illustrate a couple of embodiments of a pusher body.

FIG. 8 is rear view of the holding chute showing one embodiment of an exit gate.

FIG. 9 illustrates the closed exit gate shown in FIG. 8 with a cow head protruding through an opening in the exit gate.

FIG. 10 illustrates one embodiment of a head positioner.

FIG. 11 illustrates a cow being restrained and lifted within one embodiment of the squeeze chute.

### DESCRIPTION OF THE PREFERRED EMBODIMENTS

Embodiments of the invention include a squeeze chute for temporarily confining an animal, both domesticated and wild, while it is being inspected or treated. Embodiments of the squeeze chute have at least one restraint mechanism for restraining the movement of an animal held in the chute. Preferable restraint mechanisms include a pair of side restraints, a rear pusher and restraint and/or a head positioner. The restraint mechanism cooperate to restrain the movement of the animal within the squeeze chute. Certain embodiments of both the side grippers and the pusher are horizontally and vertically extensible and retractable from the top rails on which they are mounted.

It is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in any appropriately detailed structure.

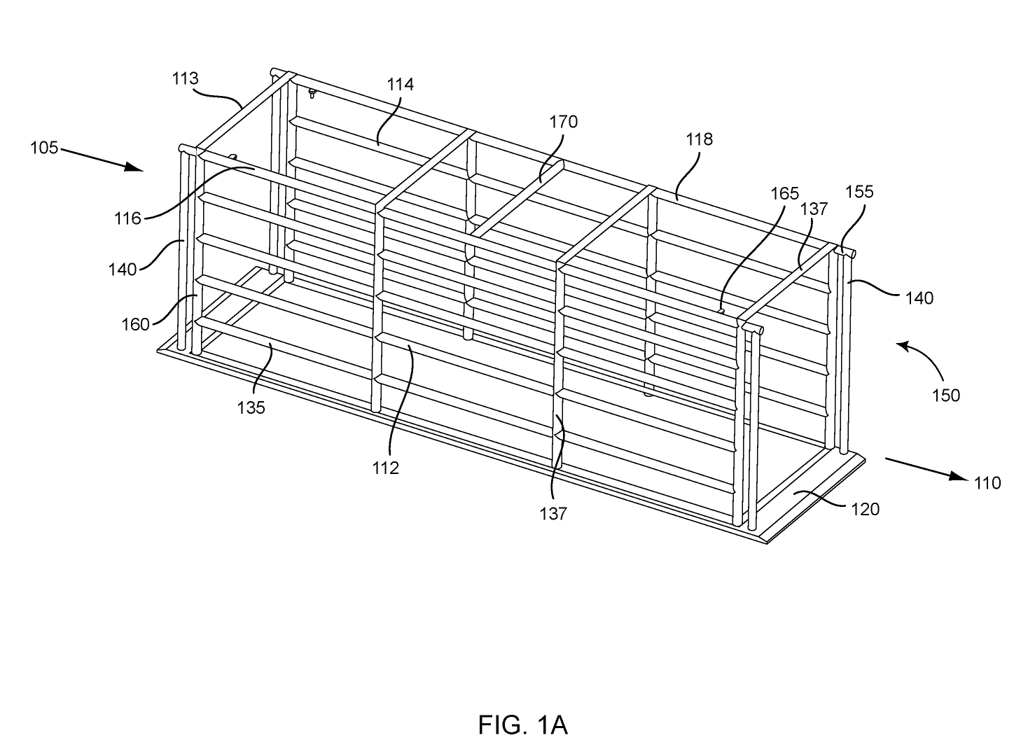

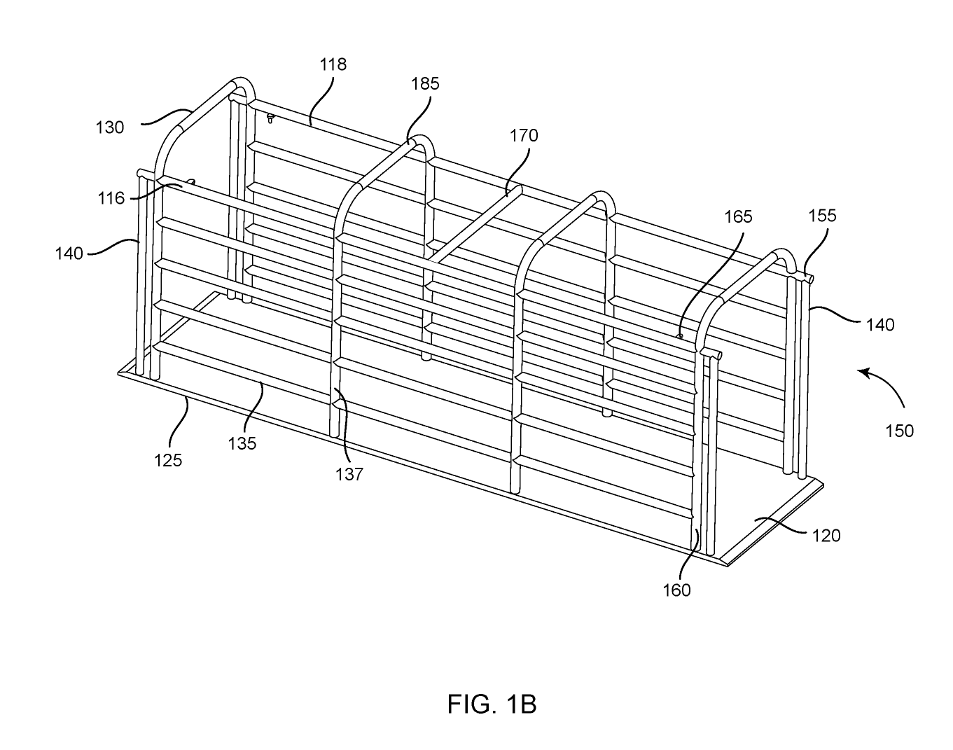

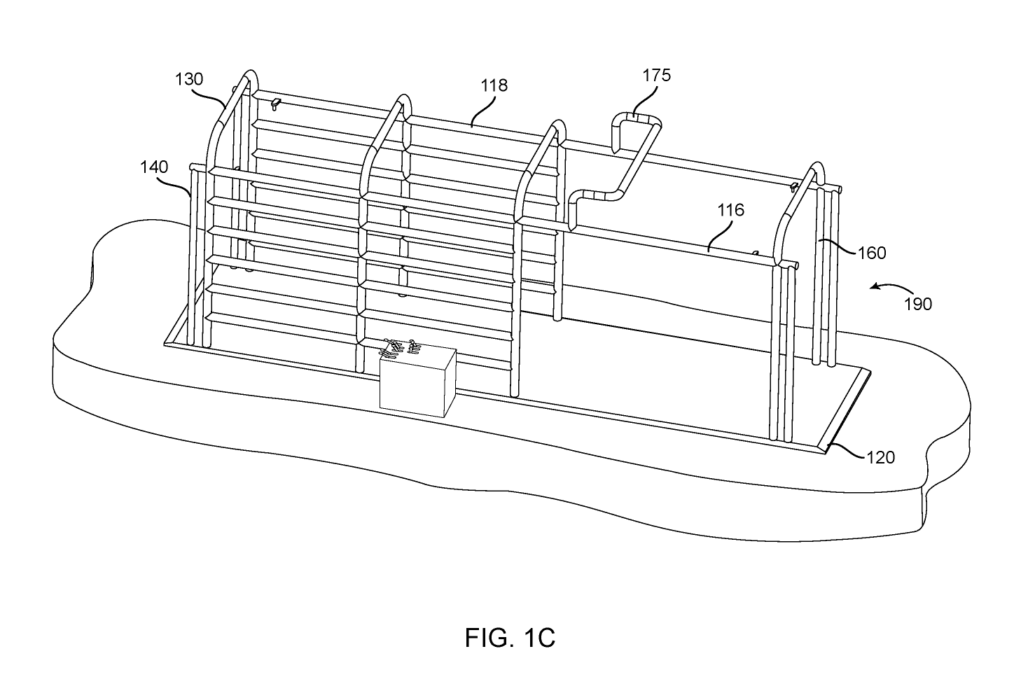

Referring now to the drawings, and initially to FIGS. 1A and 1B, it is pointed out that like reference characters designate like or similar parts throughout the drawings. The Figures, or drawings, are not intended to be to scale. For example, purely for the sake of greater clarity in the drawings, component size and spacing are not dimensioned as they actually exist in the assembled embodiment.

### The Holding Chute

FIG. 1A is a schematic outline of one embodiment of a basic rectangular holding chute framework 100. The holding chute framework 100 has an entrance 105, an exit 110, a first side 112, and a second side 114. The chute has four tubular top rails that are joined into a top rectangle and four bottom rails joined into a substantially similar bottom rectangle, where the top and bottom rectangles are joined at their four corners with end posts 160. The top rail 116 for the first side 112 and the top rail 118 for the second side 114 are in a top plane and have substantially identical circumferences and outer diameters. Typically, the rails are steel tubes and are welded together. The rectangular framework 100 generally rest on a base 120. The first side 112 and the second side 114 typically have multiple vertical bars 137 that connect the top and bottom rectangles and multiple horizontal bars 135 that connect the vertical bar 137 and the end posts 160. Optionally, the chute framework 100 has one or more transverse horizontal tubes 170 that span the top rails 116 and 118.

FIG. 1B illustrates another embodiment of the holding chute framework 150 with a base 120 incorporated into the framework. Typically, the structural elements of the framework 150 are steel and are typically joined by arc welding. The structural base 120 is composed primarily of steel tubing and plate mounted on a horizontal rectangular steel base plate 125 which rests on a flat ground surface. The chute framework 150 has two sides with each side having two end posts 160. Each side typically has multiple vertical bars 137 and horizontal bars 135 that provide the basic structure of the sides. The chute framework 150, like the chute framework 100, has one or more optional transverse horizontal tubes 170 that span the top rails 116 and 118.

The chute framework 150 has at least two (with four being shown in FIG. 1B) tubular transverse loops 130. The loops 130 are generally positioned parallel to each other and spaced along the long axis of the base plate 125. The transverse loops 130 resemble an inverted “U” with curved legs welded on one end to the top end of opposed vertical bars 137 of the two sides of the chute framework. The other end of the curved legs are directed towards the center of the chute framework and are joined by horizontal bars 185 to form the inverted “U” shape. Typically one U-shaped tubular loop 130 is mounted each end of the chute framework 150 (i.e., the entrance 105 and the exit 110).

FIG. 1C illustrates yet another embodiment of the holding chute framework 190 that is similar to the chute framework 150. The major differences being that in one section of the chute framework 190, proximal the exit 110 of the chute, the horizontal bars 185 are absent on the two sides except for the top rails 116 and 118. The other major difference illustrated is that the framework 190 has a raised offset transverse loop 175. The raised loop 175 illustrated in FIG. 1C is a “U” shape loop positioned horizontally with each leg of the “U” welded to a vertical extension that is welded to the opposed top rails 116 and 118. However, the raised loop 175 can be a variety of shapes and sizes and is typically used to mount components of the squeeze chute.

On each side of both the entrance and the exit of the various chute frameworks, a vertical cylindrical tubular gate support post 140 is outwardly positioned from each end post 160. Typically, each gate support post 140 is welded to the base plate 125 at its lower end and similarly attached by a short upper horizontal tubular support 155 to at an upper end by welding. The individual gate support posts 140 provide support for a pair of swing gates at the entrance 105 and the exit 110. A variety of sizes and shapes of swing gates may be selected for the entrance 105 and the exit 110.

The chute framework 100, 150 or 190 serves both to laterally confine animals within the holding chute and to provide a mount for other components of the squeeze chute.

### The Side Restraint Mechanism

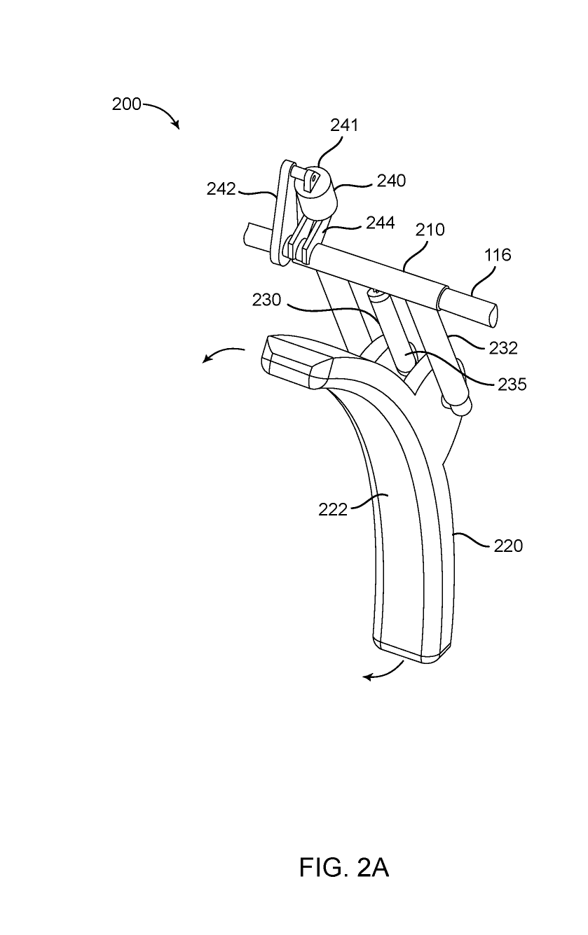

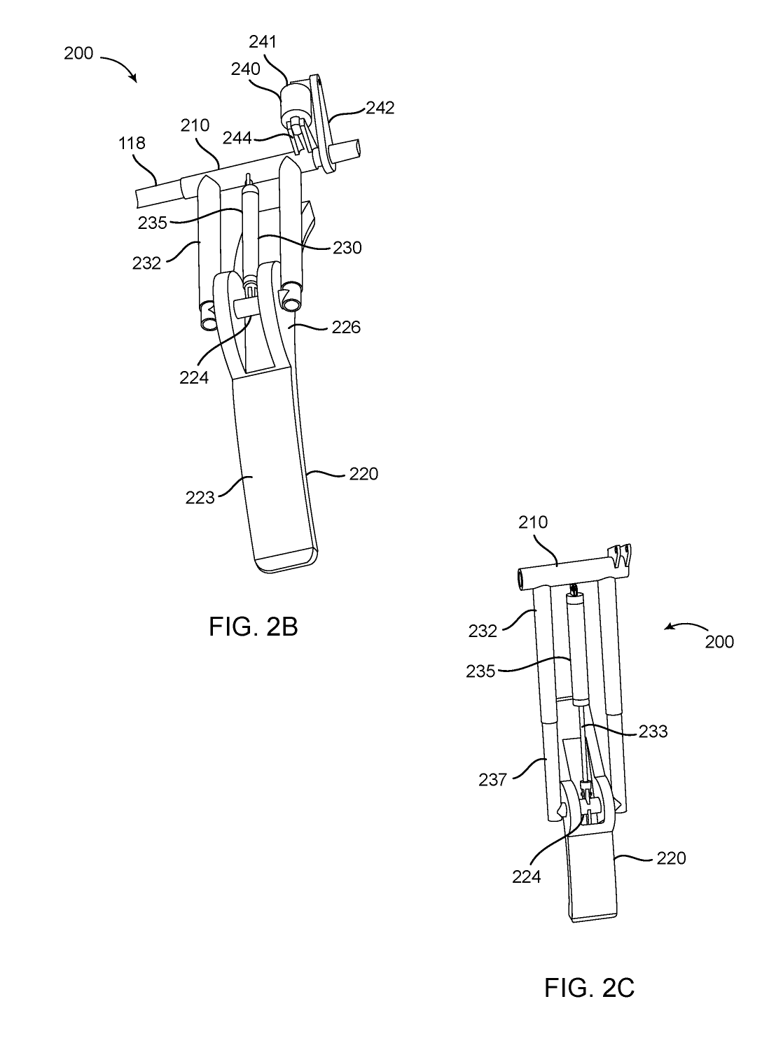

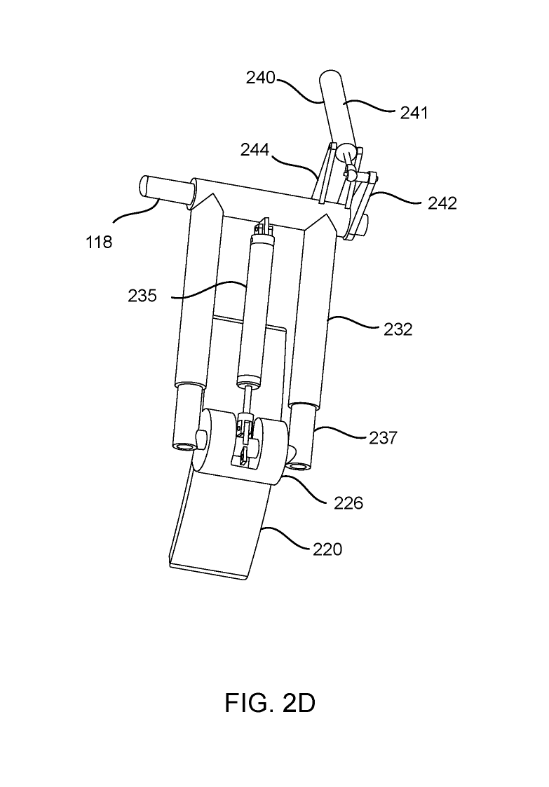

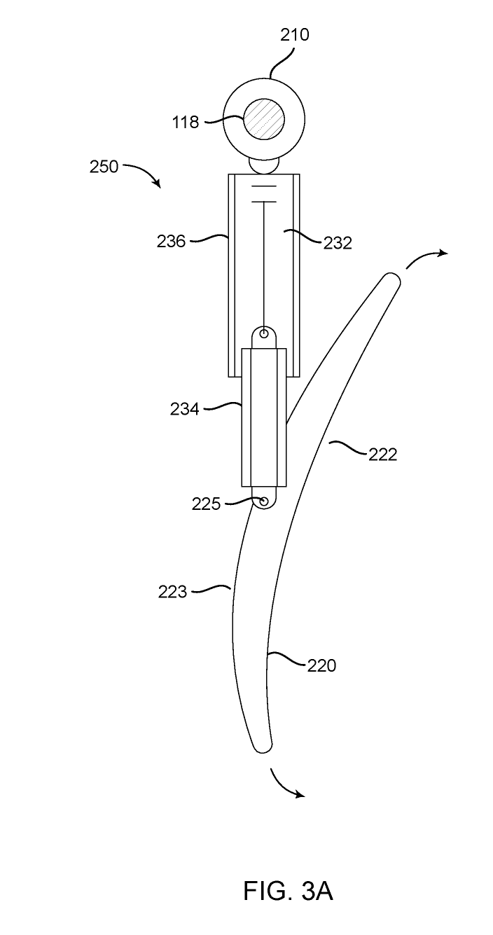

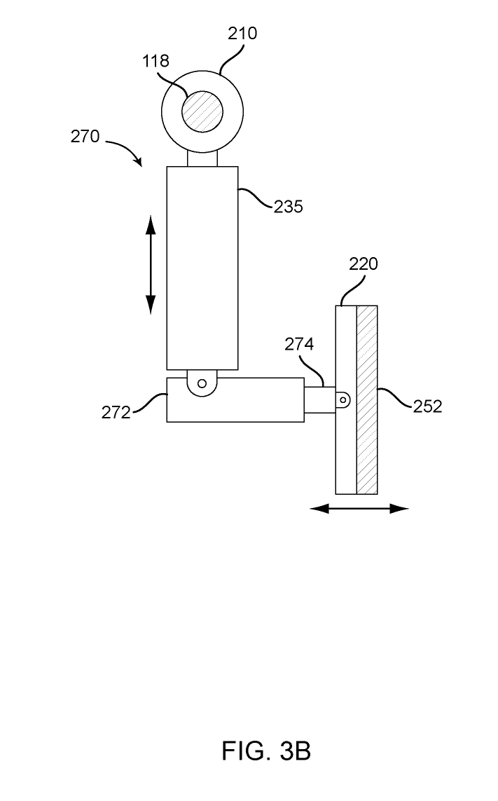

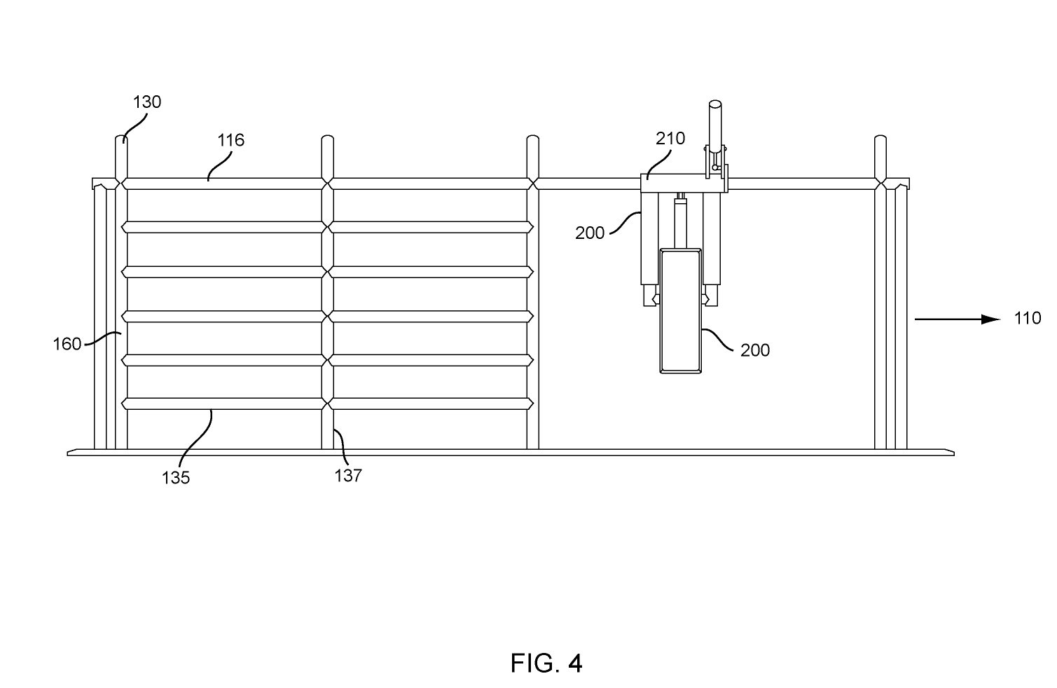

FIG. 4 illustrates a side view of a squeeze chute with a pair of substantially identical restraint mechanisms 200 mounted on the top rails 116 and 118 of the opposed sides of the chute framework 190. Embodiments of such restraint mechanisms are illustrated in FIGS. 2 A-D and FIGS. 3A-B.

Embodiments of the restraint mechanism have a gripper attached to a top rail of the squeeze chute framework and are designed to be vertically and horizontally extensible and retractable. A simple design of the restraint mechanism 270, shown in FIG. 3B, has a gripper 220 that only extends and retracts in a vertical and horizontal direction; whereas a more complex design of the restraint mechanism 200, shown in FIGS. 2A-D, has a gripper 220 that extends and retracts in a vertical direction, extends and retracts in a horizontal direction, pivots about the top rail on which it is mounted, and pivots about its attachment to a gripper extender 230.

One embodiment of the restraint mechanism 200, shown in FIGS. 2A-C, includes a tubular support 210 that encircles a top rail 116,118; an arcuate gripper 220 designed to conform to a section of the animal to be constrained by the restraint mechanism 200, a gripper extender 230 connecting the gripper 220 and the tubular support 210; a gripper swivel 224 attaching the gripper 220 to the gripper extender 230; and a restraint rotator 240 mounted on a first end to the tubular support 210 and on a second end to the top rail 116, 118 encircled by the tubular support. The restraint mechanism 200 and its component parts are described in more detail below.

The tubular support 210 is a tubular structure having a bore with an inner diameter that is slightly larger than the outer diameter of the top rails 116, 118. Prior to welding the top rails 116, 118 into the chute framework, the outer circumference of the top rail of each side, is threaded through the bore of at least one tubular support 210. Thus, each tubular support encircles and is rotatable about a top rail 116, 118.

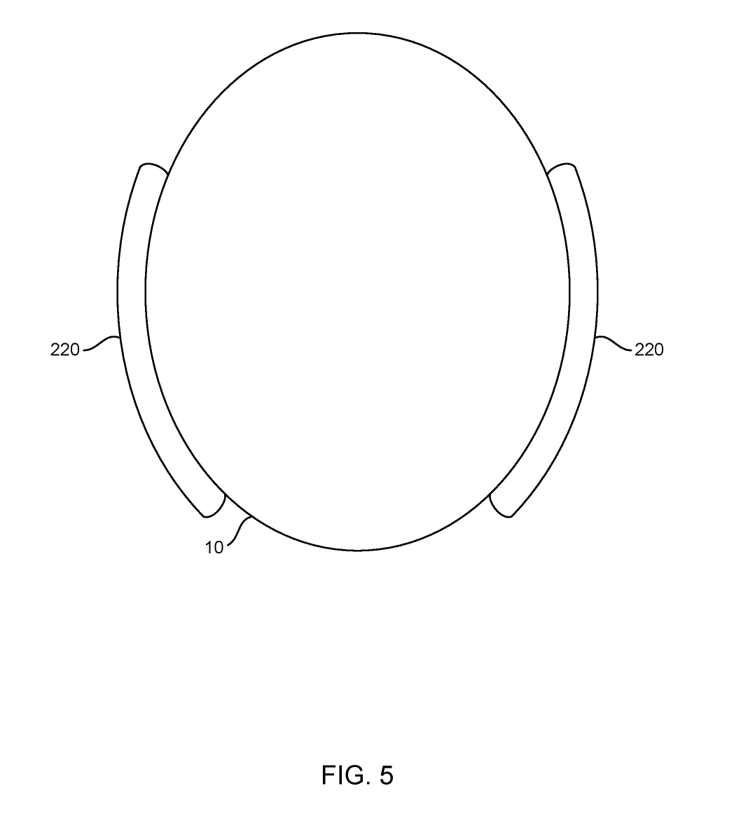

A preferred embodiment of the gripper 220 has an arcuate inner surface 222 that will grip one part of the anatomy of the animal confined, such as the rib cage and/or abdomen of a cow as schematically indicated in FIG. 5. The inner surface 222 is optionally padded and is typically designed to conform to the portion of the anatomy of the animal to be constrained by the restraint mechanism 200. The gripper 220 is optionally replaceable with other sizes and shapes of gripper depending on the animal to be constrained in the squeeze chute. The ability to swap different types and contours of grippers 220 allows the squeeze chute to be adapted for use with a variety of animals. For example, the gripper 220 shown in FIG. 2D is wider than the gripper 220 shown in FIG. 2A and the gripper 220 shown in FIG. 3B is not arcuate.

Embodiments of the gripper 220, shown in FIGS. 2A and 3A, has a pivot about which it can rotate as indicated by the arrows. One embodiment illustrated in FIGS. 2A-2D has a bifurcated arcuate extension 226 extending from its back surface 223 with a swivel pin 224 connecting the two sides of the arcuate extension 226. Another embodiment shown in FIG. 3 has a pivot point 225 attached to the back surface 223 of the gripper 220. Alternatively, the gripper 220 shown in FIG. 3B does not have a pivot about which it rotates, but is positioned in a single position such as the vertical position illustrated.

A gripper extender assembly 230 has a first end attached to the tubular support 210 and a second end attached to the gripper 220. One embodiment of the gripper extender 230 is shown in FIGS. 2A-2D. This embodiment has a hydraulic cylinder 235 attached at a first end to the tubular support 210 and a second end attached to the swivel pin 224 of the gripper 220. As the hydraulic cylinder 235 is extended or retracted, it adjusts the distance between the top rail and the gripper 220. The embodiment shown in FIGS. 2A-2D has two telescoping support tubes 232 attached to the swivel pin 224 such that whenever the support tubes are rotated with the tubular support 210 the swivel pin 224 is rotated and the gripper 220 is moved either inwardly toward the center of the chute 100 or outwardly away from the center of the chute. FIG. 2C shows the inner arms 237 of the two telescoping arms 232 and the rod 233 of cylinder 235 extended.

The restraint mechanism 200 also includes a restraint rotator 240, as illustrated in FIGS. 2A and 2D, that includes a hydraulic cylinder 241 mounted on a first end to a rigid cylinder mount 242 that is mounted on or welded to the top rail 116, 118 and attached on a second end to rigid cylinder mount 244 that is mounted on the rotatable tubular support 210. Thus, as the cylinder 241 is extended the cylinder mount 244 is pushed downward and rotates the tubular support 210, the support tubes 232 and the swivel pin 224 to move the gripper 220 inwardly toward the center of the chute 100. On the other hand, as the cylinder 241 is retracted the cylinder mount 244 is pulled upward and rotates the tubular support 210, the support tubes 232 and the swivel pin 224 to move the gripper 220 outwardly away from the center of the chute 100. Thus, the extension and retraction of the cylinder rod moves the gripper 220 in a predetermined arc that is preferably between 80 and 120 degrees. As the gripper 220 passes through this arc, the gripper goes from a substantially horizontal position with the inner surface 222 of the gripper pointing downward toward the ground to a more vertical position such that the inner surface 222 of the gripper moves inward toward the center of the chute to rest against the side of the animal constrained in the squeeze chute.

A second embodiment of a gripper mechanism 250 with a different embodiment of a gripper extender is shown in FIG. 3A. This embodiment has a cylindrical cover 236 attached at a first end to the tubular support 210 with an internal hydraulic cylinder 232 having an attached extension tube 234 with a pivot point 225 attached to the gripper 220. The internal extension tube 234 telescopes in and out of the cylindrical cover 236 as the hydraulic cylinder is extended or retracted. As the internal extension tube 234 telescopes in and out of the cylindrical cover it adjusts the distance between the top rail and the gripper 220.

A third embodiment of a gripper mechanism 270, illustrated in FIG. 3B, has a vertical extender 235 that is similar to that illustrated in FIG. 3A. The vertical extender 235 has a cylindrical cover attached at a first end to the tubular support 210 with an internal hydraulic cylinder having an attached extension tube that is attached to a horizontal extender 272. The internal extension tube telescopes in and out of the vertical extender as the hydraulic cylinder is extended or retracted. As the internal extension tube telescopes in and out of the cylindrical cover 235 it adjusts the distance between the top rail and the gripper 220. This gripper mechanism 270 also has a horizontal extender 272. The horizontal extender 272, like the vertical extender 235, has a cylindrical cover attached transversely to the vertical extender with an internal hydraulic cylinder having an attached extension tube 274 that is attached to the gripper 220. The internal extension tube 274 telescopes in and out of the horizontal extender as the hydraulic cylinder is extended or retracted. As the internal extension tube telescopes in and out of the cylindrical cover it adjusts the distance between the internal surface of the gripper 220 to the center of the squeeze chute. In the embodiment shown in FIG. 3B, the internal surface of the gripper 220 is covered with a padded surface 252.

### A Pusher and Rear Restraint

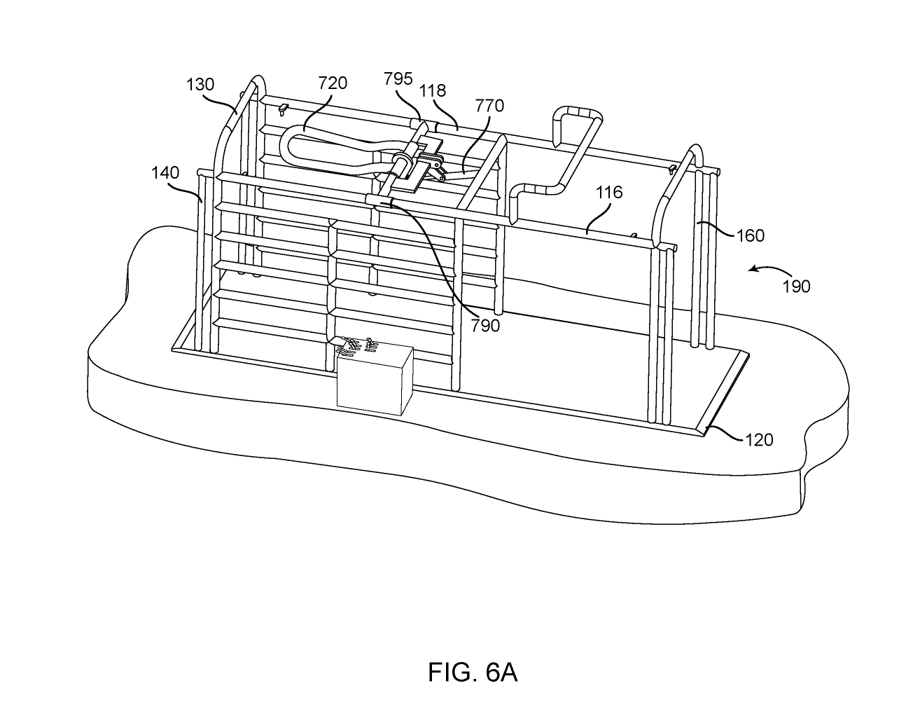

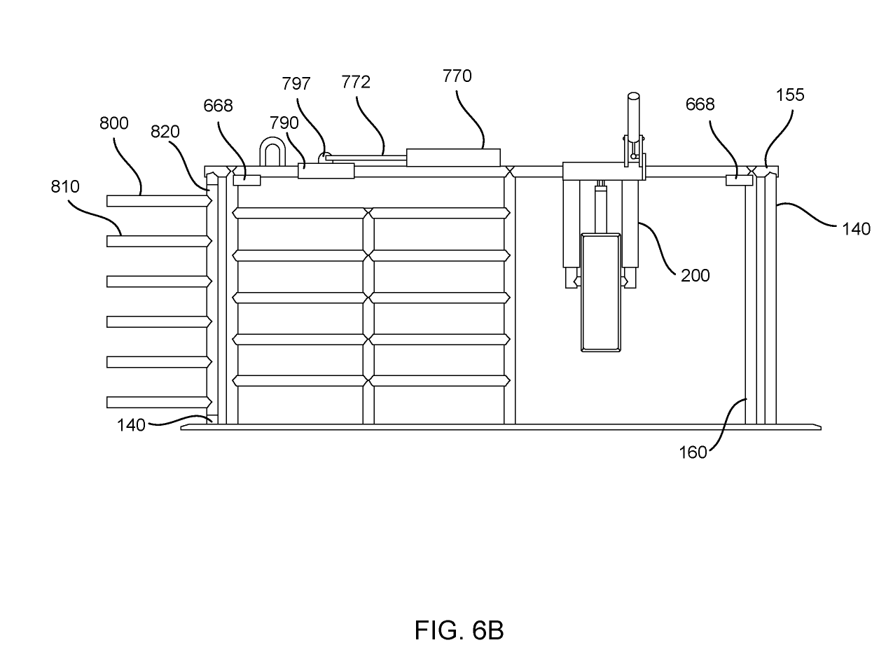

FIGS. 6A and 6B illustrate a pusher and rear restraint, also referred to as a prod or pusher, mounted on top of the squeeze chute. An embodiment of the pusher and rear restraint 700 is shown on a transverse horizontal top rail 715 which is attached at each end to a slideable tube 790 or 795. Each slideable tube 790 and 795 encircles a top rail 116 or 118 of the opposed sides of the chute structure. The transverse top rail 715 of the pusher assembly is positioned substantially parallel to the top rail 113 of the entrance 105 and is typically located either about midway along the length of the holding chute (i.e., the distance between the entrance and the exit of the chute) or closer to the entrance 105 than the exit 110 of the chute structure. The hydraulic cylinders for operating components of the pusher, such as the pusher rotator and the placement mechanism, are also mounted on the top of the squeeze chute. Typically, the hydraulic cylinders are mounted on one of the top rails 116, 118 or on one or more transverse top rails 170 attached to the top rails 116 and 118.

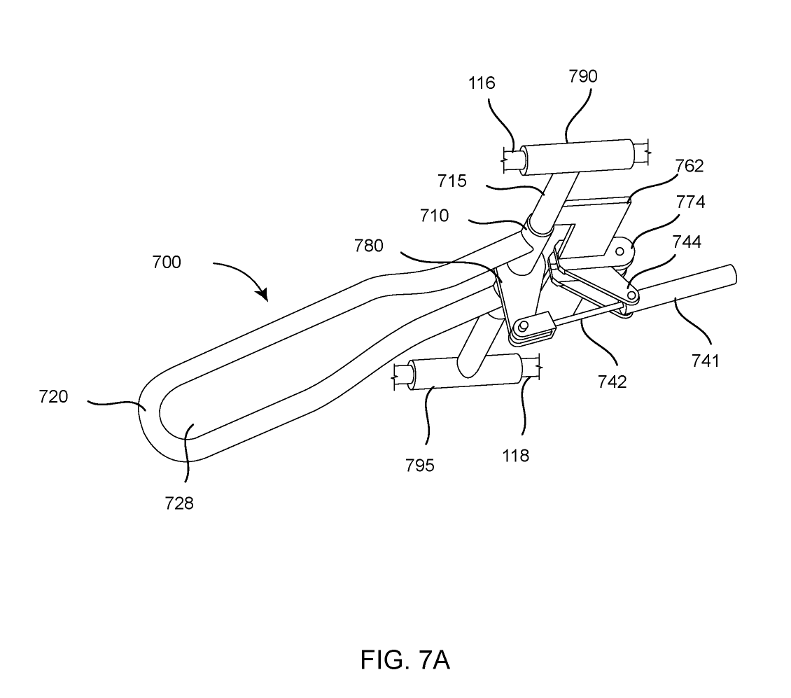

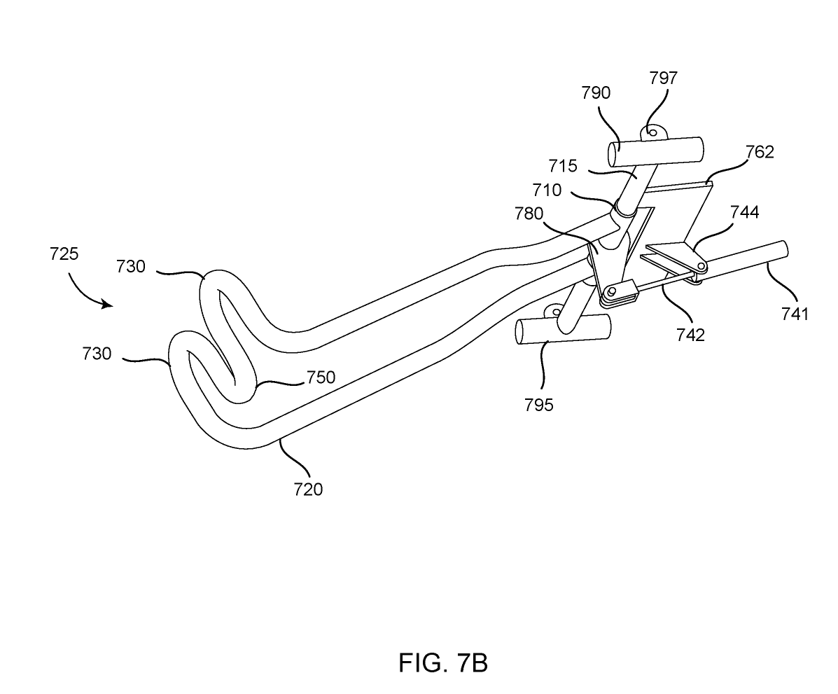

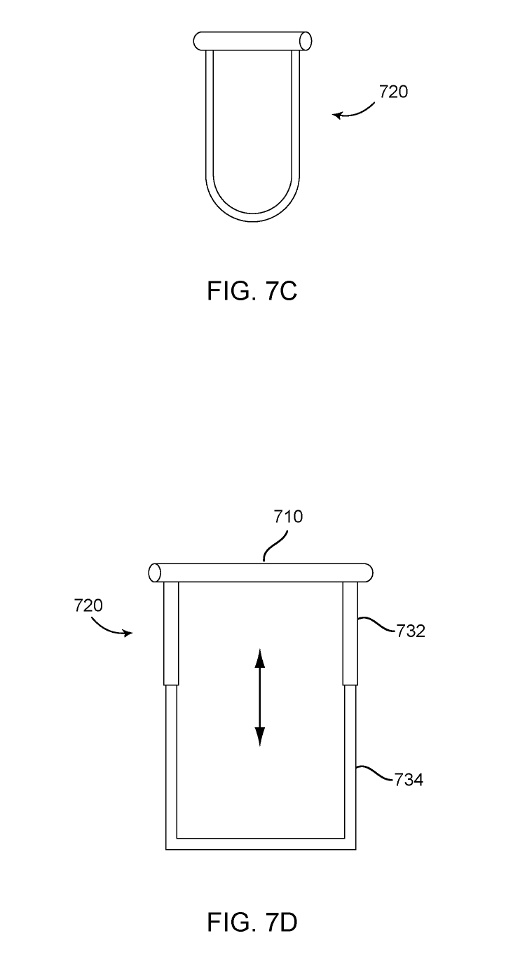

Two embodiments of the pusher and rear restraint 700 and 725 are seen in FIG. 7A and FIG. 7B respectively. Each pusher assembly has a pusher body, a pusher rotator and a pusher placement mechanism as described in more detail below. The pusher rotator rotates about the top rail 715 from a basically horizontal position to within a 30 degree angle of a vertical position. The pusher rotator governs the angle at which the pusher moves into or out of the chute. The placement mechanism governs the selective movement of the pusher into or out of the chute along the longitudinal axis of the squeeze chute. The selective rotation and placement of the pusher is used to urge the animal all of the way forward in the chute and to prevent the animal from backing up or laying down. Currently available prods or pushers are not fitted and held right up to the hind end and rear legs of the animal in the squeeze chute so that the animal is not constrained sufficiently to prevent it from backing up and/or laying down thereby rendering the animal, livestock manager or veterinarian susceptible to injury.

The pusher 700 and 725 include a support tube 710 that encircles the transverse horizontal rail 715; a slideable tube 790 that encircles a top rail 116 or 118; a slideable tube 795 that encircles the opposed top rail 116 or 118; a pusher body 720 respectively; a pusher rotator mechanism; and a pusher placement mechanism.

Slideable tubes 790 and 795 are tubular structures having bores with an inner diameter that is slightly larger than the outer diameter of the top rails 116 and 118. Prior to welding the top rails 116 and 118 into the chute framework, the outer circumference of top rail 116 is threaded through the bore of slideable tube 790 or 795 and the outer circumference of top rail 118 is threaded through the bore of slideable tube 790 or 795. Generally, the top rails 116 and 118 are positioned parallel to each other and are the same diameter such that the slideable tubes 790 and 795 could encircle either top rail 116 or 118. The tubular support 710 is also a tubular structure having a bore with an inner diameter that is slightly larger than the outer diameter of the transverse horizontal top rail 715 that the tubular support 710 encircles. Prior to welding the two ends of the horizontal rail 715 to the slideable tubes 790 and 795, the outer circumference of the support tube 710 is threaded over the transverse top rail 715. Thus, the support tube 710 is rotatable about the transverse top rail 715 and the pusher 700 or 725 is slideable along a portion of the length of chute by sliding along the length of the top rails 116, 118.

Although the pusher body 720 in FIG. 7A is shown as a loop that is narrower at the top than at the bottom, the pusher body 720 can be any shape and size such as the embodiments shown in FIGS. 7B-7D. Thus, an appropriate size and shape of the pusher body 720 can be selected depending on the animal and the particular area on the animal to be examined or treated. The ability to swap different types and contours of pusher body 720 allows the pusher to be adapted for use with a variety of animals and for a variety of uses. For example, the pusher body 720 may be arcuate in shape or custom designed to fit more closely to the rear end of the animal and its hind legs. The pusher body 720 may also be padded to make its interaction with the rear end of the animal less traumatic for the animal.

Preferred embodiments of the pusher body 720 have an opening 728 in the pusher body 720, such as shown in FIGS. 7A-7D to allow operating room for a livestock manager or a veterinarian to perform certain task at the rear end of the animal without the animal being able to back up or lay down. For example, an opening in the pusher body designed to be used at the rear of a pregnant cow allows a veterinarian access to determine the size and position of her fetus. One embodiment of the pusher body, shown in FIG. 7D, allows the operator to adjust the size of the pusher opening and/or the height of the pusher body 720 by expanding or retracting the length of one or more sections or sides of the pusher body. The example shown in FIG. 7D has two vertically extending sides, where the length of each side can be adjusted. Each side has a tubular cover 732 attached at a first end to the support tube 710. The tubular cover 732 has an internal cylinder attached to an extension tube 734 that telescopes in and out of the tubular cover 732 as the cylinder is extended or retracted.

The pusher rotator of the pusher 700 and 725 is illustrated in FIGS. 7A and 7B respectively. The pusher rotator includes a hydraulic cylinder 741 mounted on a first end to a rigid cylinder mount 744 that is welded to a plate 762 that is welded to the transverse top rail 715. A second end of the cylinder 741 is attached to a rigid mount 780 welded to the rotatable tubular support 710. Thus, as the cylinder rod 742 is extended the cylinder mount 780 is pushed toward the chute entrance and thereby rotates the tubular support 710 to move the pusher body upward to a substantially horizontal position. On the other hand, whenever the cylinder rod 742 is retracted the cylinder mount 780 is pulled toward the center of the chute and thereby rotates the tubular support 710 to move the pusher body downward to place the bottom end of the pusher body in a more vertical position so that it can be aligned with the rear end of the animal.

Alternatively, if the pusher 700 is turned over as it is mounted on the chute framework then the hydraulic cylinder 741, the cylinder mount 744 and the cylinder mount 780 would be on the top side of the pusher and the extension of the cylinder rod 742 would rotate the pusher body downward toward the interior of the chute and the retraction of the cylinder rod would rotate the pusher body upward away from the center of the chute. The pusher rotator rotates the support tube 710 around the transverse horizontal rail 715 to move the pusher body 720 in a predetermined arc that is preferably between 60 and 120 degrees. As the pusher body passes through this arc, the pusher body goes from a substantially horizontal position with the bottom of the pusher body pointing away from the center of the chute to a more vertical position such that the bottom of the pusher body moves inward toward the center of the chute.

The placement mechanism of the pusher governs the movement of the lowered pusher body 720 from the entrance of the chute towards the middle of the chute to align with the rear end of the animal and to urge the animal forward toward the exit of the chute. Once the animal is properly positioned within the chute the pusher body is pushed gently up against the animal's hind end thereby constraining the animal and preventing it from backing up or laying down.

A plan view of the pusher 700 mounted on the top of the squeeze chute is shown in FIG. 6A. The placement mechanism of the pusher 700 includes a hydraulic cylinder 770 mounted on a transverse horizontal rail 170 with a cylinder rod attached to a rigid cylinder mount 774 welded to the plate 762. Thus, as the cylinder 770 is extended the cylinder rod 772 pushes the pusher 700 away from the center of the chute toward the entrance of the chute. On the other hand, whenever the cylinder rod 772 is retracted the pusher 700 is pulled toward the center of the chute and thereby can be aligned with the rear end of the animal.

A side view of the pusher 725 mounted on the top of the squeeze chute is shown in FIG. 6B. The pusher 725 is shown in FIG. 7B. Pusher 725 is similar to pusher 700 with the exception of the shape of the pusher body and the location of the placement mechanism. The pusher body 720 of the pusher 725 consists of a loop with a narrower top than bottom and a bottom end having a pair of mirror image leg engagement loops 730, and a central leg separator loop 750 joining the outer ends of the leg engagement loops 730.

The placement mechanism of the pusher 725 includes two cylinder rod mounts 797, where one cylinder rod mount is welded on a top side of each slideable tube 790 and 795. Two hydraulic cylinders (only one seen in the side view of FIG. 6B) are mounted on the top of the opposed sides of the chute, typically on the top rails 116 and 118 and their cylinder rods are attached to the mounts 797. Thus, as the cylinder rods are extended the cylinder rods push the pusher 725 away from the center of the chute toward the entrance of the chute. On the other hand, whenever the cylinder rods are retracted the pusher 725 is pulled toward the center of the chute and thereby can be aligned with the rear end of the animal.

The Chute Gates

The squeeze chute has both an entry gate assembly 800 and an exit gate assembly 900. As illustrated in FIGS. 1A-1C and 6B, a vertical cylindrical tubular gate support post 140 is outwardly positioned from each end post 160 on each side of both the entrance and the exit of the squeeze chute. Typically, each gate support post 140 is welded to the chute base at its lower end and similarly attached by a short upper horizontal tubular support 155 at an upper end by welding. The individual gate support posts 140 provide support for a pair of swing gates at the entrance 105 and the exit 110. A variety of sizes and shapes of swing gates may be selected for the entrance 105 and the exit 110.

One embodiment of the entrance gate assembly 800 is shown in an open position in FIG. 6B. The entry gate 800 includes mirror image right hand and left hand halves, which are mounted to have a rotational fit on the entrance support posts 140. As illustrated in FIG. 6B, each gate half has a vertical gate support tube 820 with an internal diameter that is larger than the outer diameter of the support posts 140. Before the support posts 140 are welded into the entrance end of the chute framework, the bore of a gate support tube 820 is threaded over the outer surface of one of the two entry support posts 140. The horizontal finger tubes 810 are made of tubes having a diameter that is the same or smaller than the vertical gate support 820. The finger tubes 810 are coped on one end to permit them to be closely fitted and welded to the vertical gate support 820. The other end of the finger tubes 810 have a hemispherical closure cap to avoid injury to the animal passing through the entry gate. The finger tubes 810 are typically mounted in a regularly spaced vertical coplanar array along the length of the vertical gate support 820. The length of the finger tubes 810 is such that when the mounting planes of the finger tubes of a pair of mirror image gate halves are mutually rotated about 45 degrees from their fully open position, the rounded ends of the finger tubes nearly touch. This arrangement allows only one animal to enter the gate at one time. If another animal is following closely behind the animal that is entering, the gently closing finger tubes of the two halves of the entry gate will act as a warning to the second animal not to enter the chute. Thus, only the one animal is allowed entry into the squeeze chute at a time.

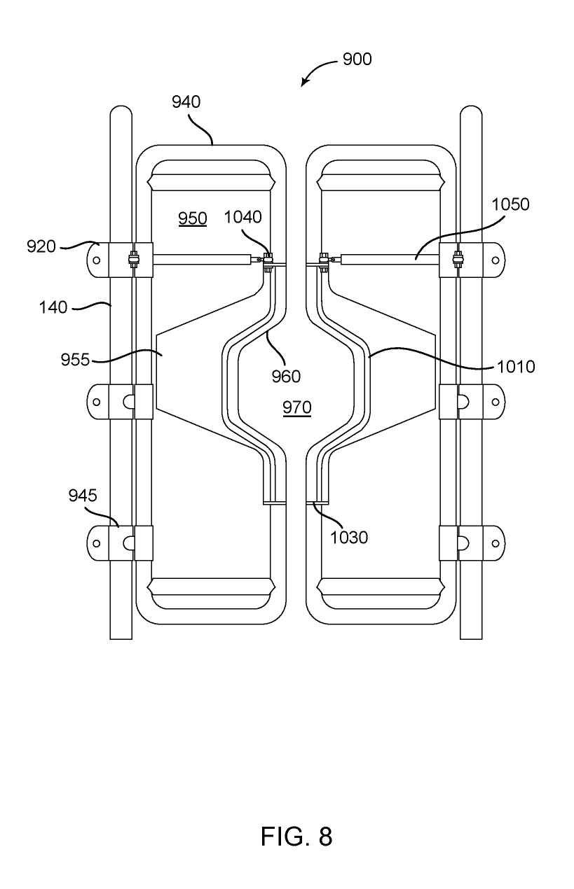

One embodiment of the exit gate assembly 900 in a closed position is shown in FIG. 8. The exit gate 900 includes mirror image right hand and left hand halves which are mounted to have a rotational fit on the exit support posts 140. Each gate half has at least two tubular segments 945 with an internal diameter that is larger than the outer diameter of the support posts 140. Before the support posts 140 are welded into the exit end of the chute framework, the bore of a tubular segment 945 is threaded over the outer surface of one of the two entry support posts 140. The tubular segments 945 can rotate around the support posts 140, but are held in their vertical position on the support posts by a weldment protrusion on the support posts beneath the tubular segments 945 to prevent their sliding down the support posts.

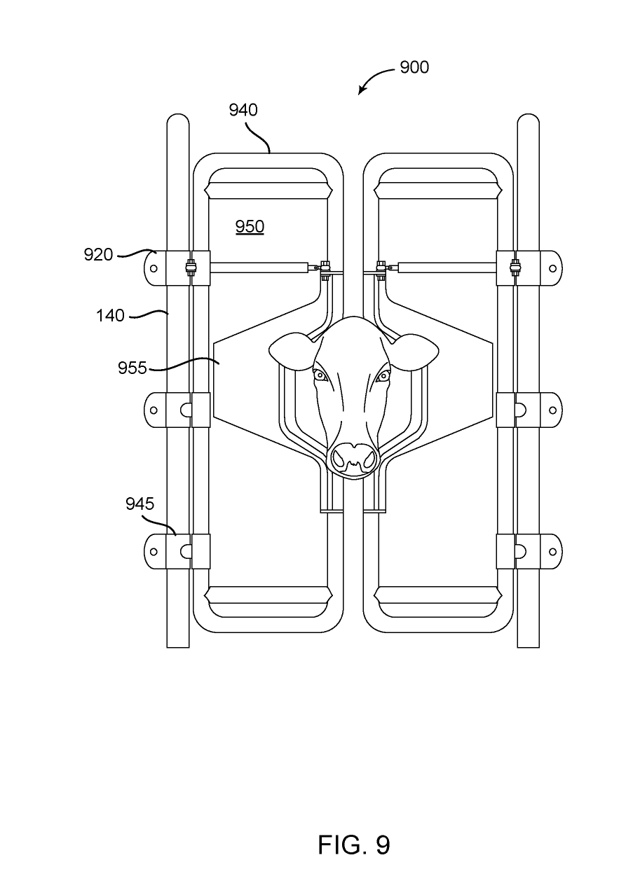

An internal frame 940 of the gate half is rotatably mounted onto a support post 140 by welding each tubular segment 945 to the outside side of the internal frame that faces the support post 140. The embodiment of the exit gate assembly 900 illustrated in FIG. 8 shows an internal frame 940 that is basically an elongated oval with a notch 960 indenting a central portion of the internal side of the frame 940 that faces away from the support post. The tubular frame 940 of the exit gate has a sheet filler 950 that fills the majority of the open space 955 within the interior of the frame 940. When the two gate halves are mounted on opposed exit support posts 140, the notch of each gate half faces the notch of the other gate half forming an opening 970 in the closed exit gate 900. When an animal fully enters the squeeze chute, the head of the animal passes through this opening which provides support for the animal's head as shown in FIG. 9. Some animals will run toward the exit of the chute towards the notch in the gates and hit the internal frame with force. Since the animal's head will protrude through the notch opening 970, the interior surface of the notch 960 is optionally padded to protect the animal from injury when it hits the internal frame.

Once the two halves of the entrance gate 800 and the exit gate 900 are rotatably mounted on the entrance 105 and the exit 110 of the chute respectively, each half of the entry gate and the exit gate is connected to a swing gate cylinder. In one embodiment of the gate opening/closing mechanism a pair of horizontal cylinder mounts 165 are attached to the top rails 116 and 118 at the entrance and exit of the chute. One end of a swing gate cylinder 668 is attached to each cylinder mount 165 on the top rails of the chute and the other end of the swing gate cylinder 668 is attached to one half of one of the swing gates (i.e., the entry gate or the exit gate). Whenever the swing gate cylinder rod extends, the connected swing gate rotates about its support post 140 and opens and whenever the cylinder rod retracts the swing gate closes.

An alternative gate opening/closing mechanism utilizes one or more cylinders mounted on each side of the entry or exit gate with the cylinder rod attached to a rotatable tubular segment (such as tubular segment 945 illustrated in FIG. 8). In this case, whenever the swing gate cylinder rod extends it pushes the rotatable segment 945 forward and the connected swing gate rotates about its support post 140 and closes the gate and whenever the cylinder rod retracts the swing gate opens.

The Head Positioner

Each exit gate half has an associated rotatable head positioner 1010 as illustrated in FIG. 8. One head positioner is attached to each half of the exit gate 900. There is a notch 1020 in the head positioner, such that when the head positioner is mounted on a gate half the notch 1020 of the head positioner and the notch 960 in the gate half overlap. Thus, when the two gate halves are closed, the notch 960 of one gate half faces the notch of the other gate half forming the opening 970. Similarly when the two head positioners are mounted on the two closed gate halves, the notch 1020 in the two head positioners face each other to form an opening that is similar in size and shape to the gate opening 970. Whenever an animal has entered the squeeze chute and its head passes through the gate opening 970 (see FIG. 9), the animal's head is also passing through the opening formed by the two head positioner notches 1020.

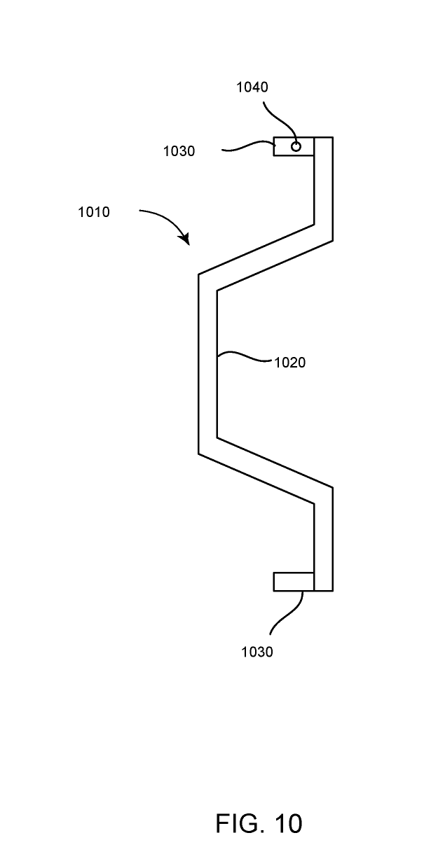

One embodiment of the head positioner 1010 is shown in FIG. 10 that has a rotatable tubular segment 1030 welded to a top end and a bottom end of the head positioner 1010. The top and bottom rotatable tubular segments 1030 are fitted over the external circumference of the gate tubular frame before it is welded closed. A cylinder rod connection point 1040 is mounted on an external surface of the top rotatable tubular segment 1030. A hydraulic cylinder 1050 is mounted on an outside surface of each exit gate half on the exterior of the squeeze chute.

The rod of the cylinder 1050 is attached to the rod connection point 1040 of the head positioner such that when the cylinder rod is extended, the head positioner rotates about the gate frame 940 so that the notch of the head positioner is biased against the head or neck of an animal with its head sticking out of the squeeze chute through the opening 970 of the chute and the opening between the two head positioners. One head positioner is rotated at a time. Whenever the cylinder rod retracts the head positioner is moved back so that it lies next to the notch 960 of the gate frame that the head positioner is attached to.

The head positioner is used to assist a livestock manager or veterinarian to constraint any excess movement of the head of the animal and allow the treatment or inspection of the face, neck, ears or eyes of the animal. The gentle constraining of the animal's head during routine procedures, such as vaccinations, allows the procedure to be done quicker and safer.

The Control Module

The control module 1200, such as illustrated in FIG. 6A, provides the hydraulic power to operate the squeeze chute. Internal details of the control valving and provision of hydraulic power are well understood by those skilled in the art and hence are not described in detail. The box of the control module typically contains a hydraulic reservoir, a electric motor driven pump, control valving, a return line filter, pressure gauges, and hydraulic connections to the cylinders such as those operating the gates, the pusher, the restraint mechanisms, and the head positioners. The hydraulic connections to the double acting cylinders are by means of hydraulic tubing and jumper hoses. The control valves are bidirectional with closed center positions provided so that the cylinders will not “drift”. One valve controls each gate, one valve controls the pusher, one valve controls each of the restraint mechanisms, and one valve controls each of the head positioners. The electric power for the electric motor driven hydraulic unit can be either DC from truck batteries, AC commercial line power, or possibly from a combination of batteries and rectified AC power for battery recharging.

Operation of the Squeeze Chute

Embodiments of the squeeze chute will typically have a pair of restraint mechanisms 200 attached to opposed top rails 116, 118 and a pusher 700 attached to a horizontal tube 715 that is slidable along the top rails 116, 118 as seen in FIG. 7A.

The squeeze is typically operated as follows. Initially, the entry gate 800 is opened and the exit gate 900 is closed, the pusher 700 is fully lifted so that the pusher body is almost parallel with the base of the chute, and the restraint mechanisms 200 are fully retracted so that the gripper is rotated outward away from the interior of the chute so an animal 10. At this point the animal, such as a cow or horse, will have an unimpeded entry into the squeeze chute, but its exit will be blocked by the closed exit gate 900.

When the animal 10 enters the interior of the squeeze chute, the entry gate 800 is then hydraulically closed to entrap the animal. The pusher 700 and the side restraints 200 are then positioned to constrain the penned animal so that the animal can be safely accessed by personnel. If the animal has its rump close to the entry gate 800, the pusher 700 can be rotated to a more vertical position with the pusher rotator so that it is approximately aligned with the rear of the animal. The pusher body 720 is then moved forward along the longitudinal axis of the chute with the pusher placement mechanism to urge the animal forward. Once the animal is in place in the squeeze chute, the pusher body is gently moved forward to engage the rear end and/or legs of the animal, thus restraining the animal from backing up or laying down. The restrained animal provides a much safer environment for a veterinarian or rancher that desires to examine or treat the animal.

The opposed side restraint mechanisms 200 are then lowered and positioned on both sides of the animal as follows. The gripper extender 230 is extended to lower the opposed grippers 220 until the grippers are vertically aligned with the section of the animal's anatomy that the livestock manager desires to grip, such as the abdomen or rib cage of a cow. Once the inner surface 222 of the opposed grippers are at the desired height, then the hydraulic cylinder 241 of the restraint rotator 240 is extended which pushes the cylinder mount 244 downward and rotates the tubular support 210, the support tubes 232 and the swivel pin 224 to move the gripper 220 inwardly toward the center of the chute. The gripper 220 is moved inwardly until the inner surface 222 of the opposed grippers abut the sides of the animal. As the inner surface 222 of the grippers 220 abut the sides of the animal the gripper can rotate such that the arcuate inner surface of the grippers conform to the contour of the sides of the animal as shown in FIG. 5.

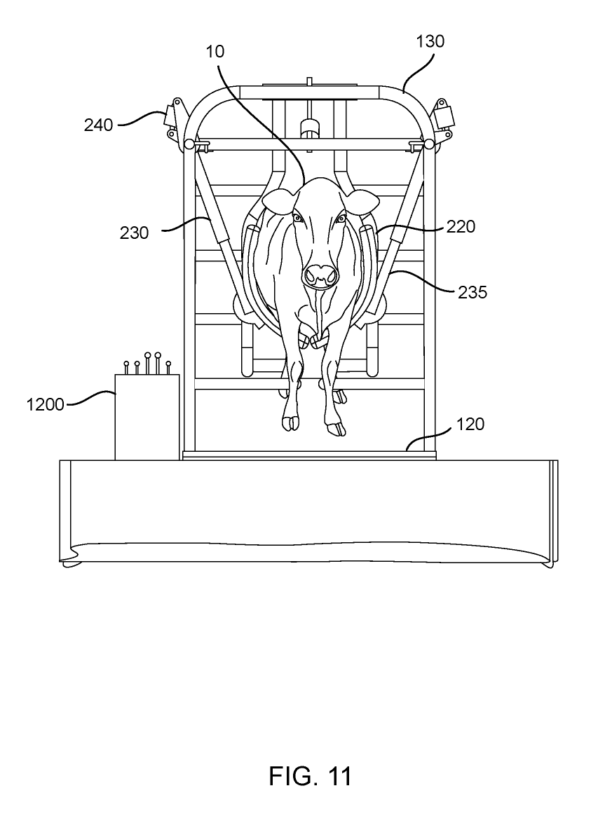

The animal is then held securely by the side restraint mechanisms 200 to prevent the axial motion of the animal in the chute. If desired, the animal the grippers can be positioned so that a portion of the gripper is pivoted under the animal. By spreading out the force of the gripper along the sides and the underside of the animal's torso, the animal can be raised so that its feet do not touch the steel base plate as shown in FIG. 11. The side restraint mechanisms 200 can also be used to shift the torso of the cow laterally within the chute. At this point, the animal will generally be sufficiently immobilized to permit safe work on the animal, with rearward directed movement and/or kicking prevented and torso motion highly restrained.

Optionally, if the animal is constrained in the squeeze chute with its head protruding through the opening 970 in the exit gate 900, one head positioner 1010 at a time can be rotated inward toward the center of the opening 970 and gently biasing the animal's head to move either to the right or to the left (depending on which head positioner is activated). The use of the head positioner allows the animals head and neck to be inspected or treated safely.

Following completion of operations on the animal, the exit gate 900 can be opened and the side restraint mechanisms 200 fully retracted. The animal can then exit the chute.

### ADVANTAGES OF THE INVENTION

The squeeze chute of the present invention markedly improves the restraint of an animal enclosed within it, thereby rendering a much safer environment for the performance of veterinary or other procedures on the animal. In additionally, veterinarian or management procedures can be performed more speedily. The hydraulic operation of the squeeze chute is well suited to a dusty outdoor environment. Other advantages will be obvious to those skilled in the art.

A variety of modifications to the chute structure and function, as well as to the side restraint mechanism, the pusher, the entrance gate, the exit gate, and the head positioner can be made without departing from the spirit of the invention.

1. An animal restraining chute having:
a. a rectangular chute having an entrance, an exit, an interior, a top, a first side and a second opposed side, wherein the first and second sides include a tubular top rail;
b. a first side restraint mechanism mounted on the top rail of the first side and a second side restraint mechanism mounted on the top rail of the second side, wherein each restraint mechanism is rotatable about the top rail that it is mounted on, each side restraint rotatable through a side opening in the chute proximal the chute exit between a substantially horizontal position outside of the chute to a more vertical position within the interior of the chute and wherein each side restraint has a gripper pivotally attached to the side restraint wherein the gripper is vertically extendable or retractable for adjusting a distance between the pivotal attachment of the gripper and the top rail on which the restraint mechanism is mounted; and
c. a pusher mounted on a horizontal cross-rail that is transverse to the top rails of the first and second sides, wherein the pusher is rotatable about the horizontal cross-rail that it is mounted on, the pusher is rotatable between a preselected first position that is a substantially horizontal position away from the interior of the chute to a preselected second position that is a more vertical position closer to the interior of the chute and wherein the pusher is movable toward and away from the interior of the chute along a longitudinal axis of the chute such movement along the two side top rails mounting the side restraints.

2. The animal restraining chute of claim 1, wherein each side restraint mechanism includes:
a support tube that encircles a portion of a length of the top rail on which the restraint mechanism is mounted on, wherein the encircled portion of the top rail is aligned with the side opening;
a gripper extender having a first end attached to the support tube and a second end attached to the gripper, wherein the extension or retraction of the gripper extender adjusts the distance between the top rail and the gripper; and
a gripper rotator having a hydraulic cylinder mounted on a first end to the support tube and a second end mounted to the top rail on which the restraint mechanism is mounted.

3. The animal restraining chute of claim 2, wherein the gripper is arcuate and its point of attachment is to the gripper extender.

4. The animal restraining chute of claim 3, wherein each side restraint mechanism rotates about the top rail in a predetermined arc ranging between 80 to 120 degrees.

5. The animal restraining chute of claim 4, wherein the substantial horizontal position of the first and second side restraints about 30 degrees or less of being horizontally coplanar with the top rails of the first and second sides of the chute.

6. The animal restraining chute of claim 4, wherein the grippers of the first side restraint mechanism and the second side restraint mechanism are rotated and extended to exert bias against a ventral region of a quadruped.

7. The animal restraining chute of claim 1, wherein the pusher includes:
a tubular pusher support having a bore with an inner diameter larger than the cross-rail outer diameter, wherein the inner diameter of the bore of the pusher support encircles a section of the cross-rail;
a pusher body having a proximal end mounted on the pusher support and a distal end;
a pusher rotator having a hydraulic cylinder mounted on a first end to the pusher support and a second end attached to the cross-rail; and
a pusher placement mechanism having a hydraulic cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles.

8. The animal restraining chute of claim 7, wherein the pusher body has an opening.

9. (canceled)

10. The animal restraining chute of claim 1, wherein the pusher rotates about the cross-rail in a predetermined arc ranging between 60 and 120 degrees.

11. The animal restraining chute of claim 10, wherein the pusher is rotated and longitudinally adjusted along the longitudinal axis of the chute to exert bias against a rear end of an animal in the interior of the chute.

12. An animal holding chute including:
a. a rectangular chute having an entrance gate, an exit gate, an interior, a top, a first side and a second opposed side, the first and second sides include a tubular first and second top side rail;
b. a first restraint mechanism mounted on the first top side rail and a second restraint mechanism mounted on the second top side rail opposite the first restraint mechanism, wherein each restraint mechanism is rotatable about the top rail that it is mounted on through a side opening in the chute proximal the chute exit between a substantially horizontal position outside of the chute to a more vertical position within the interior of the chute and wherein each restraint mechanism includes
a tubular gripper support encircling a segment of the top side rail on which the restraint mechanism is mounted wherein the encircled segment of the top side rail is aligned with the side opening,
a gripper,
a gripper extender having a first end attached to the gripper support and a second end attached to the gripper, wherein the extension or retraction of the gripper extender adjusts the distance between the gripper support and the gripper, and
a gripper rotator having a hydraulic cylinder mounted on a first end to the top rail with a cylinder rod attached to the gripper support, wherein the extension or retraction of the cylinder rod rotates the restraint mechanism about the top rail on which it is mounted; and
c. a pusher mounted on a horizontal cross-rail that is transverse to the top rails of the first and second sides, wherein the pusher is rotatable about the horizontal cross-rail that it is mounted on, the pusher is rotatable between a preselected first position that is a substantially horizontal position away from the interior of the chute to a preselected second position that is a more vertical position closer to the interior of the chute and wherein the pusher is movable toward and away from the interior of the chute along a longitudinal axis of the chute such movement along the two side top rails mounting the side restraints.

13. The animal holding chute of claim 12, wherein the pusher includes:
a tubular pusher support encircling a segment of the cross-rail;
a pusher body having a proximal end mounted on the pusher support and an opposed distal end;
a pusher rotator having a hydraulic rotator cylinder mounted on a first end to the pusher support and a second end mounted to the cross-rail, wherein the extension or retraction of a rotator cylinder rod rotates the restraint mechanism about the cross-rail; and
a pusher placement mechanism having a hydraulic placement cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles wherein the extension or retraction of the rod end of the placement cylinder moves the pusher toward and away from the interior of the chute along a longitudinal axis of the chute.

14. The animal restraining chute of claim 12, wherein the gripper is arcuate and is pivotally attached to the gripper extender.

15. The animal restraining chute of claim 12, wherein each side restraint mechanism rotates about the top rail in a predetermined arc of between 80 and 120 degrees.

16. An animal holding chute including:
a. a rectangular chute having an entrance gate, an exit gate with a head opening that allows a head of an animal in the chute to pass through the head opening to an exterior of the chute, an interior, a top, a first side and a second opposed side, wherein the first and second sides include a tubular first and second top side rail; and
b. a pusher rotatably mounted on a horizontal cross-rail that is transverse to the first and second top side rails, the pusher having
a tubular pusher support encircling a segment of the cross-rail;
a pusher body having a proximal end mounted on the pusher support and an opposed distal end;
a pusher rotator having a hydraulic rotator cylinder mounted on a first end to the pusher support and a second end mounted to the cross-rail, wherein the extension or retraction of a rotator cylinder rod rotates the pusher about the cross-rail between a substantially horizontal position away from the interior of the chute to a substantially vertical position closer to the interior of the chute; and
a pusher placement mechanism having a hydraulic placement cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles wherein the extension or retraction of the rod end of the placement cylinder moves the pusher toward and away from the interior of the chute along a longitudinal axis of the chute.

17. The animal holding chute of claim 16, further comprising a first restraint mechanism mounted on the first top side rail and a second restraint mechanism mounted on the second top side rail opposite the first restraint mechanism, wherein each restraint mechanism having
a tubular gripper support encircling a segment of the top side rail on which the restraint mechanism is mounted on wherein the encircled segment is aligned with an opening in the side of the chute proximal the exit,
an arcuate gripper,
a gripper extender having a first end attached to the gripper support and a second end attached to the gripper, wherein the extension or retraction of the gripper extender adjusts the distance between the gripper support and the gripper, and
a gripper rotator having a hydraulic cylinder mounted on the top of the chute and a cylinder rod attached to the gripper support, wherein the extension or retraction of the cylinder rod rotates the restraint mechanism about the top rail on which it is mounted through the side opening between a substantially horizontal position outside of the chute to a substantially vertical position within the interior of the chute.

18. (canceled)

19. An animal holding chute including:
a. a rectangular chute having an entrance, an exit, an entrance gate, an exit gate with a head opening that allows only a head of an animal in the chute to pass through the head opening to an exterior of the chute, an interior, a top, and a first side and a second opposed side, wherein the first and second sides include a tubular first and second top side rail running parallel to the longitudinal axis of the chute from the entrance to the exit, a plurality of side rails mounted on the sides parallel to the first and second side rails that extend from the entrance at least 50 percent of a length of the first and second top side rails towards the exit leaving an opening under the top rails proximal the exit;
b. a first restraint mechanism mounted on the first top side rail and a second restraint mechanism mounted on the second top side rail opposite the first restraint mechanism, wherein each restraint mechanism is rotatable about the top rail that it is mounted on through the side opening from a substantially horizontal position outside of the chute to a more vertical position within the interior of the chute, wherein each restraint mechanism having
a tubular gripper support encircling a segment of the top side rail on which the restraint mechanism is mounted wherein the encircled segment of the top side rail is aligned with the side opening,
an arcuate gripper,
a gripper extender having a first end attached to the gripper support and a second end pivotally attached to the gripper, wherein the extension or retraction of the gripper extender adjusts the distance between the gripper support and the gripper, and
a gripper rotator having a hydraulic cylinder mounted on a first end to the top rail with a cylinder rod attached to the gripper support, wherein the extension or retraction of the cylinder rod rotates the restraint mechanism about the top rail on which it is mounted; and
c. a pusher rotatably mounted on a horizontal cross-rail that is transverse to the first and second top side rails, the pusher having
a tubular pusher support encircling a segment of the cross-rail;
a pusher body having a proximal end mounted on the pusher support and an opposed distal end;
a pusher rotator having a hydraulic rotator cylinder mounted on a first end to the pusher support and a second end mounted to the cross-rail, wherein the extension or retraction of a rotator cylinder rod rotates the restraint mechanism about the cross-rail between a substantially horizontal position away from the interior of the chute to a substantially vertical position closer to the interior of the chute; and
a pusher placement mechanism having a hydraulic placement cylinder mounted on the top of the chute wherein an extendable rod end of the cylinder is attached to the cross-rail and wherein each end of the cross-rail is transversely mounted to a tubular section having a bore that encircles one of the top side rails thereby rendering each tubular section slideable along an adjustment length of the top side rail that it encircles wherein the extension or retraction of the rod end of the placement cylinder moves the pusher toward and away from the interior of the chute along a longitudinal axis of the chute
whereby the pusher urges an animal entering the chute forward to place its head through the head opening to secure the animal within the chute, then the first and second side restraints are rotated and extended to exert bias against a ventral region of the animal.

20. The animal holding chute of claim 19, wherein the exit gate has two half gates such that when the exit gate is closed a gate indentation in one half gate is aligned with the gate indentation in the other half gate to form the head opening.

21. The animal holding chute of claim 20, further comprising a head positioner rotatably mounted on each half gate wherein the head positioner has a positioner indentation that is positioned over the gate indentation of the half gate on which the positioner is mounted.
